(19) United States
(12) Patent Application Publication
(10) Pub. No.: US 2022/0405315 A1
(43) Pub. Date: Dec. 22, 2022

(54) RANKING TEXT SUMMARIZATION OF TECHNICAL SOLUTIONS

(71) Applicant: International Business Machines Corporation, Armonk, NY (US)

(72) Inventors: Ruchi Mahindru, Elmsford, NY (US); Daniela Rosu, Mount Kisco, NY (US); David Konopnicki, Haifa (IL)

(21) Appl. No.: 17/354,136

(22) Filed: Jun. 22, 2021

(51) Int. Cl. G06F 16/34; G06F 16/36; G06N 20/00

(52) U.S. Cl. CPC G06F 16/345; G06F 16/367; G06N 20/00

(57) ABSTRACT

An approach to ranking identified technical solutions summaries may be provided. The approach may include extracting data from technical tickets, subject matter expert reports, and online forum data. The approach may include receiving data relating to prior applications of one or more technical solutions. Steps associated with a technical solution may be included in the information from the prior application of the technical solutions and updated based on the information from prior applications of technical solutions. The approach may include generating a risk score and a cost score for the updated technical solution based on contextual factors associated with a user or machine. The approach may include enriching a static summary for the technical solution with the cost and risk score. The approach may include ranking the enriched summary against multiple potential technical solutions.

### BACKGROUND OF THE INVENTION

The present invention relates generally to the field of technical system changes, more specifically to ranking summaries of technical system changes generated by natural language understanding techniques.

Technical support agents assist users to resolve a broad range of technical issues quickly and effectively. When a support agent searches for a resolution to a user's technical issue, numerous results may be presented, with one or more prospective solutions being highlighted within technical solution documentation. The support agent must then decide the best course of action. Many times, the solution can change for different users based on numerous individualized factors. In some situations, an identified solution may not even be relevant to the issue at hand, but rather based on the keyword match in the solution document. The technical support agent must decide which solution is best for the user but may not have all of the relevant information associated with the user's technical problem or know whether a prospective solution is even feasible for a particular user's technical problem.

### SUMMARY

Embodiments of the present disclosure include a computer-implemented method, computer system, and computer program product for technical solution summarization and ranking. The embodiments include extracting data from tickets and forum data associated with a technical solution, based on a pre-built ontology. Embodiments further include receiving information regarding prior one or more applications of the technical solution for a computing system associated with the prior applied technical solution. Also included in the embodiments is updating procedure steps of the technical solution based on the monitoring data. Additionally, included is generating a cost score associated with the updated technical solution, based on context factors and generating a risk score associated with the updated the technical solution based on context factors. Embodiments further include, enriching a static summary of the technical solution with the cost and risk score. Finally, embodiments include ranking the enriched summary, based on the cost score and the risk score.

### BRIEF DESCRIPTION OF THE DRAWINGS

FIG. 1 is a functional block diagram of a technical solution summarization ranking environment, generally designated 100, in accordance with an embodiment of the present invention.

FIG. 2 is a functional block diagram of a technical solution engine, generally designated 200, in accordance with an embodiment of the present invention.

FIG. 3 is block diagram of a high level architecture of a technical solutions summarization ranking system 300, in accordance with an embodiment of the present invention.

FIG. 4 is a flowchart of a method for technical solution summarization ranking, generally designated 400, in accordance with an embodiment of the present invention.

FIG. 5 is a flowchart of a method for context enriched technical solution summarization ranking, generally designated 500, in accordance with an embodiment of the present invention.

FIG. 6 is a functional block diagram of an exemplary computing system 10 within a technical solution summarization ranking environment, in accordance with an embodiment of the present invention.

FIG. 7 is a diagram depicting a cloud computing environment 50, in accordance with an embodiment of the present invention.

FIG. 8 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Embodiments of the current description recognize a need for customized ranking of multiple technical solutions in response to a user's technical issue. The user may be in a unique situation or require special rules that will not suffice for another user's technical issue or commonly occurring situations. For a given technical issue, multiple solutions may be available which can impact the user in different ways. Some user's may not be able to replace technical hardware themselves, while others may have budgetary constraints preventing them from performing a technical solution to replace hardware. Embodiments of the current description allow for a cognitive approach to identifying technical solutions, ranking the solutions based on the user (e.g., user profile, user's preference or availability skill required to perform the technical solution), providing a summary for the ranking of the solution, and updating the cognitive approach based on the user's behavior and solution effectiveness.

The embodiments depicted allow for ranking summarizations of technical solutions from technical documents in response to a user's technical issue query. Technical documents include, but are not limited to, user manuals, frequently asked question, prior technical issue tickets, subject matter expert descriptions, etc. The technical documents can be annotated based on a prebuilt ontology. An ontology is a language model that has been trained based on, but not limited to, one or more of previous technical issue tickets, subject matter expert defined rules/steps, technical documents, and internet forums (e.g., technical forums where users can ask questions to a community). The annotated technical documents may be summarized based on the annotations. The summary of the annotated technical document can be considered a static summary. The summaries may be stored in association with the technical solutions in a knowledge base.

In an embodiment, a user may present a query associated with a technical issue. A technical solution ranking engine can retrieve technical solutions and automatically summarize the technical solutions for the user's current situation. The technical solution ranking engine can be based on a cognitive or machine learning model. The summarized technical solution can be ranked based on effectiveness of one or more technical solutions. It should be noted that the user may have an associated user profile, which can be factored into the ranking of the solutions and include a generated summary for the technical solution for a user. The user profile may contain data including, but not limited to, one or more of user technical skill level, business policies, entitlements, service level agreements, etc.

In an embodiment, the machine learning model associated with the technical solution ranking engine may be continuously updated based on one or more predetermined factors. The ontology may continually or periodically be updated to include new technical issue tickets, forum posts, SME input, and the like. Additionally, a user input of acceptance of a presented technical solution may be used in a feedback loop to further associate the presented technical solution for user's with similar user profiles. It should be noted, similar user profiles can include skills available to perform the technical solution/resolution steps. Further, in an embodiment, the machine learning model may take into account the expected downtime and response time associated with a technical solution applied to a machine, based on machine monitoring data. The expected downtime and response time can be compared to the actual downtime and response time of an applied technical solution, based on monitoring data of the machine after the application, the expectations for downtime and uptime can be updated accordingly.

In an embodiment, there may be an “offline” architecture and an “online” architecture. “Offline” refers to the annotation of the technical solutions. The process is considered offline because it occurs before the user query process and the use of annotations to generate a static summary for the technical solution. Further, the annotations, which are based on a pre-built ontology, can be associated with entities, actions, cost, and skill associated with prior technical solutions. The offline architecture can further augment identified technical solutions with data from prior technical solutions of a similar nature.

Embodiments of the present disclosure provide a computer-implemented method, computer system, and computer program product for ranking enriched summaries technical solutions in while factoring in user context. Current technical solution identification approaches only provide technical solutions to technical issues. They fail to take into account any context associated with the user experiencing the technical issue, thus leaving the user or a customer service representative to determine which solution is best. Embodiments of the present disclosure may provide a summary of a technical solution and rank the technical solutions, while factoring in the cost associated with the solution, risk associated with the solution, and skill level of the user experiencing the technical issue. Further, embodiments of the present disclosure may also factor in additional user context relating to business policies, machine profiles, and the like.

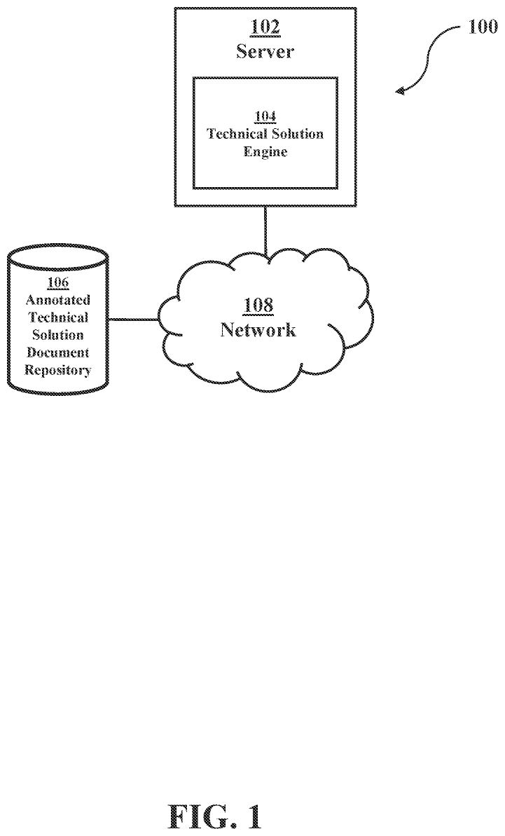

Referring now to the Figures, FIG. 1 is a functional block diagram generally depicting technical solution summarization ranking environment 100. Technical solution summarization ranking environment 100 comprises technical solution engine 104 operational on server 102, annotated technical solution document repository 106, and interconnected over network 108. In an alternative embodiment, annotated technical solution document repository 106 are remotely located from server 102.

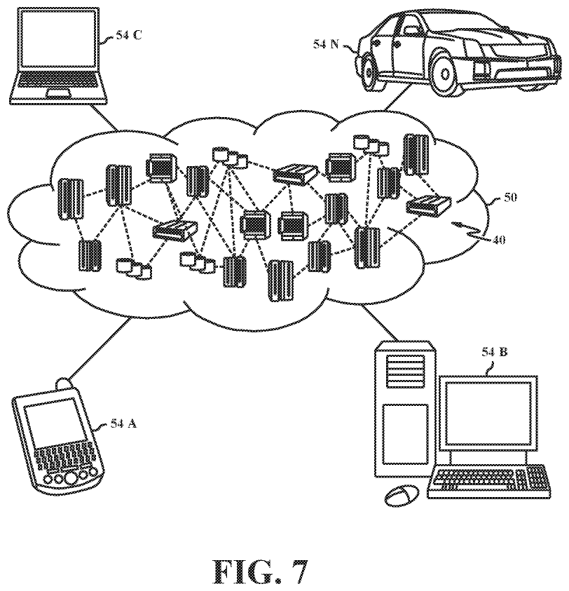

Server 102 can be a standalone computing device, a management server, a web server, a mobile computing device, or any other electronic device or computing system capable of receiving, sending, and processing data. In other embodiments, server 102 can represent a server computing system utilizing multiple computers as a server system such as in cloud computing environment 50 (depicted in FIG. 7). In an embodiment, server 102 can represent a computing system utilizing clustered computers and components (e.g., database server computers, application server computers, etc.) that act as a single pool of seamless resources when accessed within technical solution summarization ranking environment 100. In another embodiment, server 102 can be a laptop computer, a tablet computer, a netbook computer, a personal computer, a desktop computer, or any programmable electronic device or combination of programmable electronic devices capable of executing machine readable program instructions and communicating with each other, as well as annotated technical solution document repository 106, and other computing devices (not depicted) within technical solution summarization ranking environment 100 via network 108. It should be noted, while only a single server 102 is shown in FIG. 1, in other embodiments, multiple servers or other computing devices can be present within technical solution summarization ranking environment 100.

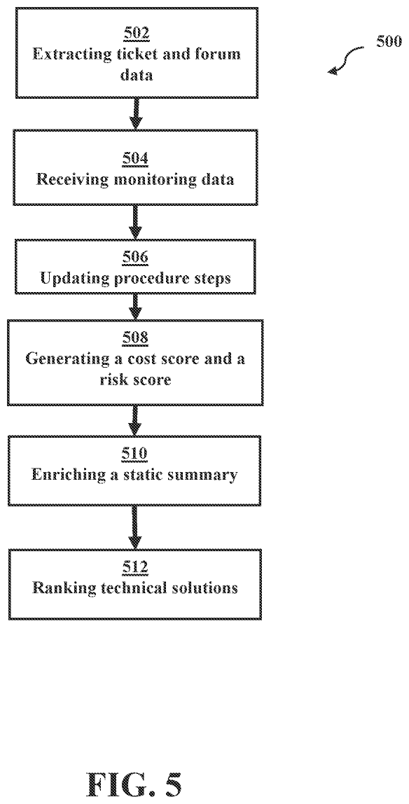

Server 102 may include components as depicted and described in further detail with respect to computer system 10 in FIG. 5. Server 102 may include components as depicted and described in further detail with respect to cloud computing node 40 of cloud computing environment 50 in FIG. 5.

Network 108 can be a telecommunications network, a local area network (LAN), a wide area network (WAN), such as the Internet, or a combination of the three, and can include wired, wireless, or fiber optic connections. Network 108 may include one or more wired and/or wireless networks that are capable of receiving and transmitting data, voice, and/or video signals, including multimedia signals that include voice, data, and video information. In general, network 108 can be any combination of connections and protocols that will support communications between server 102, technical solution engine 104, and external computing devices (not shown) within technical solution summarization ranking environment 100.

Technical solution engine 104 is a computer program capable of ranking technical solutions summaries in responses to user queries. In an embodiment, technical solution engine 104 may be operational on server 102 or multiple servers (not shown) connected via network 108. In some embodiments, technical solution engine 104 may be multiple computer programs working in unison to rank multiple technical solution summaries in response to a user query. Further, technical solution engine 104 may be multiple computer programs working in unison to dynamically annotate and generate static summaries for technical solution documents from multiple sources.

In an embodiment, technical solution engine 104 can receive information relating to prior applications of one or more technical solutions associated with a computing system. For example, a system may be running an application and collecting metrics and log data associated with the application. Technical solution engine 104 can receive the data for future processing. Further, in an embodiment, technical solution engine 104 receive metrics associated with any automated remediation results associated with a computing system or application for future processing. For example, technical solution engine 104 may receive data relating to a system downtime, parts of a system the needed replacing, time required to repair an issue.

Annotated technical solution document repository 106 is a database capable of retaining summaries of technical solution documents. In an embodiment, annotated technical solution document repository 106 is a database containing summarize technical solution documents in an ordered search index. The search index can be configured in multiple ways, for example, the index may be based on operating system, hardware, enterprise level, cost, and skill level required to perform the technical solution, etc. Further, annotated technical solution document repository 106 can be a collection of annotated documents from multiple sources, such as technical forums, customer service transcripts, service engineer descriptions, system issue tickets, user manuals, research papers, specification descriptions, etc.

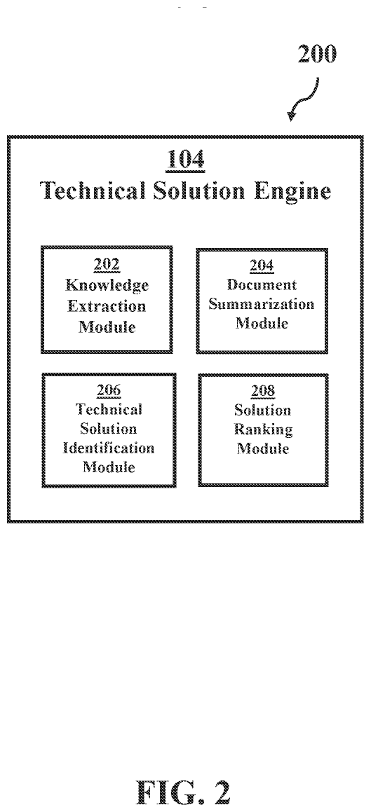

FIG. 2 is block diagram 200 comprised of technical solution engine 104. Technical solution engine 104 can be comprised of knowledge extraction module 202, document summarization module 204, technical solution identification module 206 and solution ranking module 208.

Knowledge extraction module 202 is a computer module that can identify context within technical solution documents and user queries. For example, context within technical solution documents can be a single action or multiple steps involved in performing the technical solution. Further, context can be entity recognition, including, but not limited to component parts (e.g., random access memory, hard disk drive, graphics processing unit, monitor, etc.) component part brand, type of software (e.g., operating system, web-browsers, word processing, email client, security monitoring, gaming application, etc.), machine serial number, workload priority, technical issue, etc.

In an embodiment, knowledge extraction module 202 can analyze the natural language of a technical solution document and identify the risk associated with a technical solution. For example, knowledge extraction module 202 may have a prebuilt ontology based on past issue ticket data, subject matter expert rules, customer support transcripts, and forum posts. The ontology can be a natural language processing model based on a neural network architecture (e.g., long short-term memory, recurrent neural network, bidirectional encoding representations by transformers, etc.) For example, based on previous ticket data, knowledge extraction module 202 may identify within a technical solution document that a technical solution of removing a motherboard would be a high-risk action. The entity or component would be motherboard, while the action would be removing. Further, knowledge extraction module 202 can identify a cost associated with components entities that are part of a technical solution. In the immediately preceding example, knowledge extraction module 202 may identify a motherboard as an expensive component.

Further, knowledge extraction module 202 can identify context within a user query. For example, a user may write a description or forward an error message from a machine to technical solution engine 104. Knowledge extraction module 202 can identify the context of the query or error message. For example, a user query could say, “how did the RAM in my GPU fail?” or “why is the fan in my desktop tower so loud?” An error message from a machine may say, “CPU temperature at critical level, liquid coolant pump failure detected. Coolant liquid low”. In the first example, knowledge extraction module 202 may recognize RAM and GPU as entities and fail as the action. Further, in the second example, “fan” and “desktop tower” may be recognized as component entities and make loud noise would be interpreted as the action. In the third example, CPU and coolant pump may be recognized as component entities and failure detected would be recognized as the action, while low would be recognized as a detail associated with the coolant pump.

Document summarization module 204 is a computer module that can be configured to annotate technical solution documents and generate static summaries based on the annotations. Document summarization module 204 can utilize multiple documents in generating summaries from the annotations for a technical solution document. Document summarization module 204 can have a machine learning capability that leverages prior knowledge associated with technical solutions from multiple sources and continuously updates the knowledge as new sources become available.

In an embodiment, document summarization module 204 can recognize the context identified by knowledge extraction module 202 and associate it with various factors. For example, in a technical solution document, if GPU and RAM have been identified as component entities, while replace has been identified as the action, document summarization module 204 can annotate the risk associated with the action. Risk can mean the chance of the action not solving the issue, the impact to business operations, and/or chance of injury to person/damage to property.

Additionally, in an embodiment, document summarization module 204 can annotate the technical document with a cost for steps or actions associated with a technical solution. For example, the action of replacing a GPU could be categorized or scored. The score could be on a sliding scale (e.g., 1 to 10). It could include factors such as if the user could replace the component, tooling required to perform the action (identified within the solution document itself or tickets associated with the document), machine downtime, etc.

In another embodiment, document summarization module 204 can be configured to annotate a skill level associated with a technical solution document. For example, in a technical document, the action of replacing a CPU liquid cooling unit may be classified as a difficult action above the general skill level of most users. In another example, in a technical document, cleaning a desktop cooling fan may be classified as an easy task that is well within the general skill of most users.

In an embodiment, document summarization module 204 can generate a static summary for a technical solution document based on the annotation of the document. The summary may be a compilation of the annotations. In another embodiment, the summary may be a general description of the actions and/or steps associated with the technical solution document, including the additional annotations. In another embodiment, the summary can be the annotations themselves, and any additional data augmentation from solutions engineer notes. For example, a technical solution document may describe replacing the mother board of an MRI control unit. A solutions engineer note from a prior ticket may have a description relating to accessing the motherboard in the best manner, not described in the technical document.

In an embodiment, document summarization module 204 can save the summaries and annotations associated with technical solution documents in annotated technical solution document repository 106. In some embodiments, document summarization module 204 can arrange the search index within annotated technical solution document repository 106 in various ways, including, but not limited to annotation detail frequency.

Technical solution identification module 206 is a computer module that can be configured to identify technical solutions for a user's technical issue. In an embodiment, technical solution identification module 206 can receive the context identified by knowledge extraction module 202 for a user query or machine error message. Based on the extracted entities, issues, and actions, technical solution identification module 206 can search annotated technical solution document repository 106 and identify documents that correspond to the entities, issues and actions identified by knowledge extraction module 202.

In an embodiment, technical solution identification module 206 can extract received monitoring metrics and update the procedure of the identified technical solution. For example, technical solution identification module 206 can dynamically detect any steps within an identified technical solution that can be skipped. Technical solution identification module 206 can base this on prior automated remediations associated with prior technical solutions. Technical solution identification module 206 can also be configured to add additional steps into the procedure of an identified technical solution, based on the prior automated remediations, technical issue tickets and/or subject matter expert reports.

In another embodiment, technical solution identification module 206 can receive monitoring metrics (e.g., machine performance) and/or machine uptime (e.g., indicating that the machine was already rebooted). For example, if a machine requires a reboot as one of the steps of a technical solution, if the machine was recently rebooted, that step may be skipped.

Solution ranking module 208 is a computer module that can be configured to assign a score to an identified solution and rank the solution based on the user. In an embodiment, solution ranking module 208 can receive a user profile associated with the user that presented the query or sent the error message description. For example, the user may have answered questions relating to skill level, security entitlements, and machine type or serial number. In another example, a user may be from an enterprise or business with service level agreement, business policies, approval requirements, and or compliance regulations.

In an embodiment, solution ranking module 208 can assign a complexity score to the technical solution associated with a document based on the annotations and summary, while also factoring in the user profile information. For example, if a machine requires a reconfiguration of an OS in a mission critical workload due to a hard drive corruption, multiple solution options may be presented. Based on the annotations, a score may be calculated in the following manner: the procedure requires a person with high skills to perform each step in the solution receives a higher score. If the machine profile on which to apply the procedure is mission critical, it would receive a higher score than a secondary database. If the machine has parts under warranty, the motherboard under warranty would receive a higher score than a battery under warranty.

In another embodiment, each step of an identified solution can have a cost and risk assigned by solution ranking module 208 in the following manner: Cost=skill factor*cost of part*time required for application of the solution. Risk can be calculated in the following manner: risk=(sum of each operation, where each operation is assigned a numerical value increasing with the complexity of the operation)*average fix failure rate per month*machine profile (complexity of the machine).

In another embodiment, solution ranking module 208 can rank the scored solutions. Ranking the scored solutions can take into account multiple factors. For example, scored solutions that are in opposition (e.g., for skill or entitlement) to a user's profile will be removed from the rankings. The ranking can include ranking the scored solutions based on cost, risk, skill level, or business impact. For example, reconfiguring an OS could be determined to be the least expensive option, while replacing an HDD would be considered the most expensive. In another example, replacing the HDD might be ranked higher than reconfiguring the OS because the HDD has a history of failure.

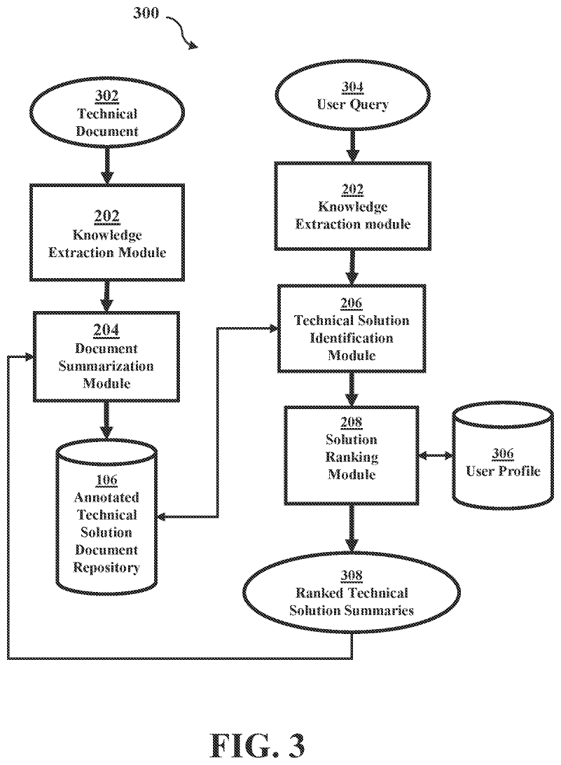

FIG. 3 is a block diagram of a high-level architecture of a technical solutions summarization ranking system 300, in accordance with an embodiment of the present invention. It is to be understood, high level architecture of a technical solutions summarization ranking system 300 is only one embodiment, as many different high-level architectures may be utilized within the scope and spirit of this disclosure.

Technical document 302 is a document that can be from a corpus or a repository. In an embodiment, technical document 302 can be posts from a forum, subject matter expert reports, troubleshooting manuals, user manuals, and/or prior technical issue tickets. While only one technical document is mentioned in FIG. 3, multiple technical documents may be used to generate a functional technical solutions summarization ranking system 300. It should also be noted that multiple technical documents from more than one location can update annotated technical solution document repository 106 dynamically through technical solution engine 104 retrieving or receiving technical documents 302 via network 108 or an administrative user's input (not shown).

For ease of envisioning the high-level architecture of FIG. 3, it is to be understood that knowledge extraction module 202, document summarization module 204, technical solution identification module 206, and solution ranking module 208 are operational within technical solution engine 104 (as shown in FIG. 2). Further, in an embodiment, technical solution engine 104 may be present on multiple computing machines such as server 102 all connected via network 108. The functional components of FIG. 3 may be present on different computing machines, but operational on one or more instances of technical solution engine 104.

Technical document 302 are fed into knowledge extraction module 202. As stated above, knowledge extraction module 202 can analyze technical document 302 and determine the technical solution via a prebuilt domain specific ontology and/or natural language understanding. Further, knowledge extraction module 202 can generate context and entity understanding for technical document 302.

Document summarization module 204 can receive the technical solution and context for technical document 302 and generate annotations for technical document 302. The annotations for technical document 302 can be risk, cost, and skill level. In some embodiments, technical document 302 can be annotated by document summarization module 204 with augmentations, based on other related technical documents. For example, augmentations can be special instructions or notes relating to the steps of the solution not contained within the technical document from subject matter expert reports and/or technician tickets. Further, document summarization module 204 can generate a static summary for technical document 302. The annotations and static summary can be stored in association with technical document 302 within annotated technical solution document repository 106.

User query 304 can be a question from a user, an error message from a computing machine, and/or an input from a customer service representative (e.g., human or chatbot) relating to a technical issue. In an embodiment, user query 304 can be a questionnaire completed by a user, including information such as machine type, operating system, processing unit, and the like.

Knowledge extraction module 202 can receive user query 304. Knowledge extraction module 202 can use a prebuilt domain specific ontology and/or natural language understanding to extract context from user query 304. The context can be the action and entities relating to the issue involved in the user query. In some embodiments, user query 304 may be an utterance that is received by knowledge extraction module 202 and broken down into machine understandable format. The machine understandable format can be analyzed by knowledge extraction module 202 through a natural language understanding model to determine the technical issue.

Technical solution identification module 206 receives the output of knowledge extraction module 202 in response to the user query 304. Technical solution identification module 206 can identify and determine if a solution for the identified technical issue exists within annotated technical solution document repository 106. In an embodiment, the output can be the identified technical issue. In some embodiments, the output can be the context (e.g., external conditions during the technical issue, task being performed during the technical issue, system conditions during issue, etc.) and/or the identified technical issue. Technical solution identification module 206 can search annotated technical solution document repository 106 for solutions to the identified technical issue and/or the context surrounding user query 304. The technical solutions associated with an annotated technical solution document can be identified and sent to solution ranking module 208. It should be noted, technical solution identification module 206 may search a search index within annotated technical solution document repository 106 utilizing more than one solution relating to a technical issue or solutions relating to a component part or context identified within user query 304.

Solution ranking module 208 can receive the identified technical solutions, generate a score for the technical solutions, and rank the technical solutions based on the generated score. In an embodiment, solution ranking module 208 can receive the annotated technical solution documents identified by technical solution identification module 206. In an embodiment, solution ranking module 208 can generate a solution score based on the annotations of the annotated technical document for the technical solution. In an embodiment, solution ranking module 208 can generate a solution score for the identified solution based on characteristic of user profile 306 and the annotations of the technical document. It should be noted that user profile 306 may contain information about a user, including computing machine details, user access entitlements, service level agreements, business policies, and the like. A solution score may be related to one aspect of the annotations (e.g., cost, risk or skill level) or an overall solution score for the solution combining the scores of each annotation. Solution ranking module can rank the technical solutions according to the generated solution score or scores. In an embodiment, multiple versions of the technical rankings may be generated and accompanied by the static summaries of the technical document, explaining the rankings and the generated scores for the technical solution. It should be noted that the ranked technical solution summaries 308 can be used to update the document summarization module 204 via a machine learning capability, based on a selection by the user.

In another embodiment, solution ranking module 208 can compute and update downtime and response time for a technical solution. The downtime and response time is re-computed based on the collection of monitoring data from the machine before and after application of the technical solution. For example, a technical solution was expected to take three hours and the technical solution solved the issue in four. In another example, a response time took three hours, rather than the expected 2 hours. In yet another example, the downtime of a system was estimated to be three hours based on prior monitoring data, application of the technical solution caused a downtime of six hours.

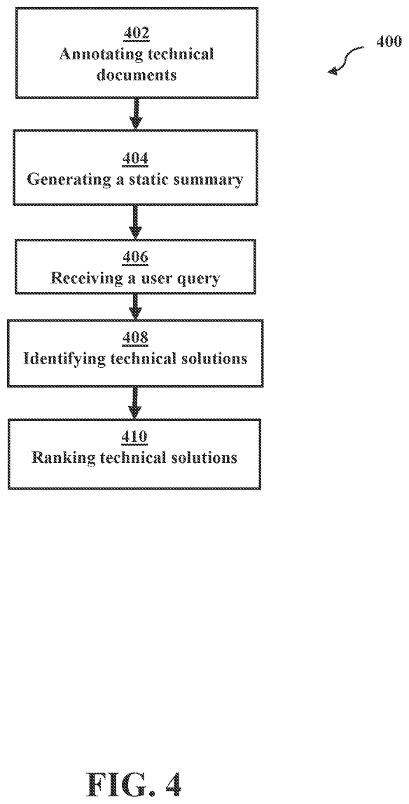

FIG. 4 is a flowchart depicting method 400 for technical solution summary ranking, in accordance with an embodiment of the present invention.

At step 402, document summarization module 204 can annotate technical documents 302. For example, knowledge extraction module 202 can determine the context, entities, and actions of a technical document associated with a solution to a technical issue. Document summarization module 204 can generate annotations for the document, including cost associated with performing the solution, risk associated with performing the solution, and user skill level required to perform the solution.

At step 404, document summarization module 204 can generate a static summary for technical document 302. For example, technical document 302 may be a troubleshooting manual containing many solutions to many technical issues. Multiple annotations may be generated due to multiple solutions being present. Knowledge extraction module 202 identified stop points for each solution based on natural language understanding of the context of the document. Document summarization module 204 can generate a static summary for each identified solution within the manual. In an embodiment, document summarization module 204 can generate a static summary condensing the steps of a solution and including the annotations including risk, cost, and skill. The annotated documents and static summaries can be stored in annotated technical solution document repository 106.

At step 406, user query 304 can be received by knowledge extraction module 202. User query 304 can be analyzed for content and data relating to a technical issue associated with the user query. For example, user query 304 may have multiple entities relating to the technical issue. Knowledge extraction module 202 can identify the entities, context, and actions based on a prebuilt domain specific ontology and or a natural language understanding model.

At step 408, technical solutions for user query 304 can be identified by technical solution identification module 206. For example, the context and actions associated with the technical issue of user query 304 can be used to find solutions within annotated technical solution document repository 106. The technical document associated with an identified solution can be pulled for further processing.

At step 410, solution ranking module 208 can rank the identified technical solutions. In an embodiment, solution ranking module 208 can generate a solution score each for identified document based on the annotations of the technical document corresponding to the identified technical solution. The technical solution can be ranked by solution ranking module 208 according to the solution score. In an embodiment, the ranked solutions can be presented to a user by solution ranking module 208 and include the static summaries providing an explanation of why the solutions are ranked in that order.

FIG. 5 is a flowchart of a method for context enriched technical solution summarization ranking, generally designated 500, in accordance with an embodiment of the present invention.

At step 502, knowledge extraction module 202 extracts ticket data and forum data from technical issue tickets and forum posts stored in annotated technical solution document repository 106.

At step 504, technical solution engine 104 receives monitoring data associated with a system. In an embodiment, technical solution engine 104 can be an application or program running in the background of a computing system. Technical solution engine 104 may be monitoring or receiving condition reports or real time data from the system or another program configured to monitor the tasks of a system. Further, monitoring data may be associated with a prior technical solution or automated remediation.

At step 506, technical solution identification module 206 can update procedure steps associated with a technical solution. In an embodiment, document summarization module 204 can generate a static summary for a technical solution document which is stored in annotated technical solution document repository 106, technical solution identification module 206 can use the monitoring data and the data extracted from step 502 to update the static summary associated with a technical solution. The update can be adding additional steps to the procedure, removing steps from the procedure, or a combination of the two.

At step 508, technical solution identification module 206 can generate a cost score and a risk score for the updated procedure. In an embodiment, the additional or fewer steps of the updated technical solution can be associated with costs and risk based on the extracted ticket data forum data, and/or monitoring data.

At step 510, document summarization module 204 can enrich the static summary of the updated technical solution with the generated risk score and the generated cost scores from step 508. Further, in an embodiment, document summarization module 204 can store the enriched static summary in annotated technical solution document repository 106.

At step 512, solution ranking module 208 can rank the enriched technical solutions summaries based on the generated cost and risk score. Solution ranking module 208 can factor in the context from the user profile in ranking the enriched summaries. For example, a user may be risk adverse to replacing a low performing a graphics processing unit (“GPU”) based on a history of GPU failures due to overheating in the machine in question Therefore, a technical solution replacing the cooling unit with a higher performing cooling unit would be ranked higher than replacement of the GPU.

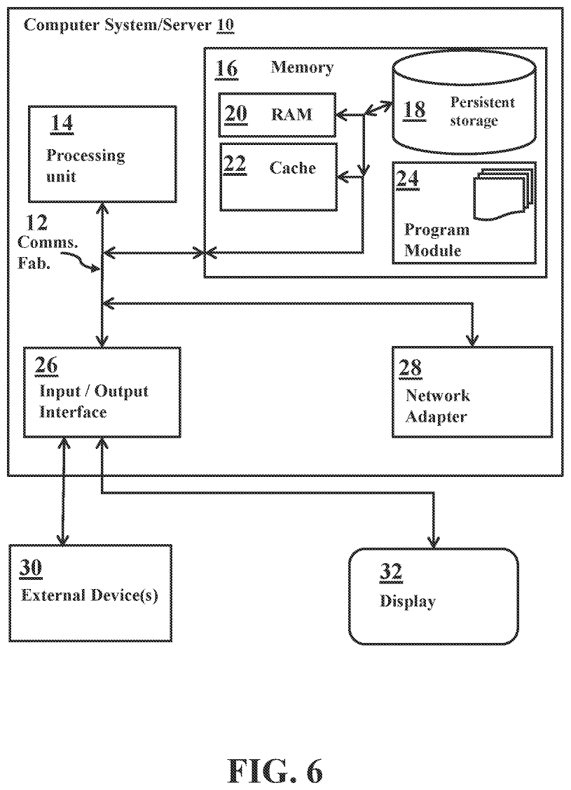

FIG. 6 depicts computer system 10, an example computer system representative of servers 102, or any other computing device within an embodiment of the invention. Computer system 10 includes communications fabric 12, which provides communications between processing unit 14, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Computer system 10 includes processing unit 14, cache 22, memory 16, network adaptor 28, input/output (I/O) interface(s) 26 and communications fabric 12. Communications fabric 12 provides communications between cache 22, memory 16, persistent storage 18, network adaptor 28, and input/output (I/O) interface(s) 26. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses or a crossbar switch.

Memory 16 and persistent storage 18 are computer readable storage media. In this embodiment, memory 16 includes persistent storage 18, random access memory (RAM) 20, cache 22 and program module 24. In general, memory 16 can include any suitable volatile or non-volatile computer readable storage media. Cache 22 is a fast memory that enhances the performance of processing unit 14 by holding recently accessed data, and data near recently accessed data, from memory 16. As will be further depicted and described below, memory 16 may include at least one of program module 24 that is configured to carry out the functions of embodiments of the invention.

The program/utility, having at least one program module 24, may be stored in memory 16 by way of example, and not limiting, as well as an operating system, one or more application programs, other program modules, and program data. Each of the operating systems, one or more application programs, other program modules, and program data or some combination thereof, may include an implementation of a networking environment. Program module 24 generally carries out the functions and/or methodologies of embodiments of the invention, as described herein.

Program instructions and data used to practice embodiments of the present invention may be stored in persistent storage 18 and in memory 16 for execution by one or more of the respective processing unit 14 via cache 22. In an embodiment, persistent storage 18 includes a magnetic hard disk drive. Alternatively, or in addition to a magnetic hard disk drive, persistent storage 18 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Network adaptor 28, in these examples, provides for communications with other data processing systems or devices. In these examples, network adaptor 28 includes one or more network interface cards. Network adaptor 28 may provide communications through the use of either or both physical and wireless communications links. Program instructions and data used to practice embodiments of the present invention may be downloaded to persistent storage 18 through network adaptor 28.

I/O interface(s) 26 allows for input and output of data with other devices that may be connected to each computer system. For example, I/O interface 26 may provide a connection to external devices 30 such as a keyboard, keypad, a touch screen, and/or some other suitable input device. External devices 30 can also include portable computer readable storage media such as, for example, thumb drives, portable optical or magnetic disks, and memory cards. Software and data used to practice embodiments of the present invention can be stored on such portable computer readable storage media and can be loaded onto persistent storage 18 via I/O interface(s) 26. I/O interface(s) 26 also connect to display 32.

Display 32 provides a mechanism to display data to a user and may be, for example, a computer monitor or virtual graphical user interface.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes 40.

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

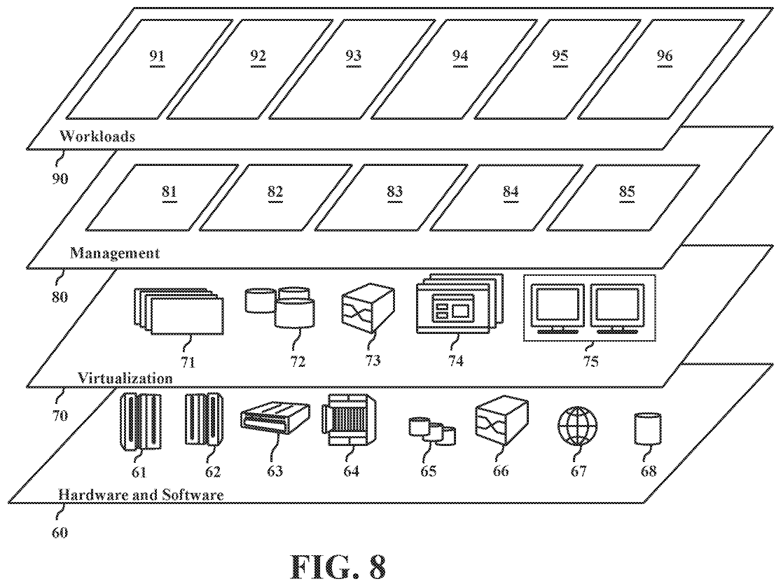

Referring now to FIG. 8, a set of functional abstraction layers provided by cloud computing environment 50 (depicted in FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and technical solution summary ranking 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

What is claimed is:

1. A computer-implemented method for ranking enriched technical solution summaries, the method comprising:
extracting, by a processor, data from tickets and forum data associated with a technical solution, based on a pre-built ontology;
receiving, by the processor, information regarding prior one or more applications of the technical solution for a computing system associated with the prior applied technical solution;
updating, by the processor, procedure steps of the technical solution based on the monitoring data;
generating, by the processor, a cost score associated with the updated technical solution, based on context factors;
generating, by the processor, a risk score associated with the updated the technical solution based on context factors;
enriching, by the processor, a static summary of the technical solution with the cost and risk score; and
ranking, by the processor, the enriched summary, based on the cost score and the risk score.

2. The computer-implemented method of claim 1, further comprising:
annotating, by the processor, a plurality of technical solution documents for the system based on a prebuilt ontology; and
generating, by the processor, a static summary for each of the plurality of technical solution documents based on the annotations of each of the plurality of technical solution documents.

3. The computer-implemented method of claim 2, further comprising:
receiving, by the processor, a user query for a technical issue associated with the system; and
identifying, by the processor, one or more technical solutions for the user query from the annotated technical solution documents.

4. The computer-implemented method of claim 1, further comprising:
receive, by the processor, a user input associated with feedback for the user query; and
updating, by the processor, the cost score and the risk score factors based on the user input based on a machine learning model.

5. The computer-implemented method of claim 1, wherein updating procedure steps is comprised of removing steps.

6. The computer-implemented method of claim 1, wherein updating procedure steps is comprised of adding steps.

7. The computer-implemented method of claim 1, wherein context factors are comprised of at least one of the following: business, service level agreement, a user profile, a machine history, a machine profile, a machine entitlement.

8. A computer system for ranking enriched technical solution summaries, the system comprising:
a processor;
a readable storage media; and
computer program instructions to:
extract data from tickets and forum data associated with a technical solution, based on a pre-built ontology;
receive information regarding prior one or more applications of the technical solution for a computing system associated with the prior applied technical solution update procedure steps of the technical solution based on the monitoring data;
generate a cost score associated with the updated technical solution, based on context factors;
generate a risk score associated with the updated the technical solution based on context factors;
enrich a static summary of the technical solution with the cost and risk score; and
rank the enriched summary, based on the cost score and the risk score.

9. The computer system of claim 8, further comprising operations to:
annotate a plurality of technical solution documents for the system based on a prebuilt ontology; and
generate a static summary for each of the plurality of technical solution documents based on the annotations of each of the plurality of technical solution documents.

10. The computer system of claim 9, further comprising operations to:
receive a user query for a technical issue associated with the system; and
identify one or more technical solutions for the user query from the annotated technical solution documents.

11. The computer system of claim 8, further comprising operations to:
receive a user input associated with feedback for the user query; and
update the cost score and the risk score factors based on the user input based on a machine learning model.

12. The computer system of claim 8, wherein updating procedure steps is comprised of removing steps.

13. The computer system of claim 8, wherein updating procedure steps is comprised of adding steps.

14. The computer system of claim 8, wherein context factors are comprised of at least one of the following: business, service level agreement, a user profile, a machine history, a machine profile, a machine entitlement.

15. A computer program product for technical solution summarization ranking, the computer program product including one or more computer readable storage media and program instructions stored on the one or more computer readable storage media, the program instructions including instructions to:
extract data from one or more technical issue tickets and forum data associated with a technical solution, based on a pre-built ontology;
receive information regarding prior one or more applications of the technical solution for a computing system associated with the prior applied technical solution update procedure steps of the technical solution based on the monitoring data;
update procedure steps of the technical solution based on the monitoring data;
generate a cost score associated with the updated technical solution, based on context factors;
generate a risk score associated with the updated the technical solution based on context factors;
enrich a static summary of the technical solution with the cost and risk score; and
rank the enriched summary, based on the cost score and the risk score.

16. The computer program product of claim 15, further comprising instructions to:
annotate a plurality of technical solution documents for the system based on a prebuilt ontology; and
generate a static summary for each of the plurality of technical solution documents based on the annotations of each of the plurality of technical solution documents.

17. The computer program product of claim 15, further comprising instructions to:
receive a user query for a technical issue associated with the system; and
identify one or more technical solutions for the user query from the annotated technical solution documents.

18. The computer program product of claim 15, further comprising instructions to:
receive a user input associated with feedback for the user query; and
update the cost score and the risk score factors based on the user input based on a machine learning model.

19. The computer program product of claim 15, wherein updating procedure steps is comprised of removing steps.

20. The computer program product of claim 15, wherein context factors are comprised of at least one of the following: business, service level agreement, a user profile, a machine history, a machine profile, a machine entitlement.
